(19) United States
(12) Patent Application Publication
(10) Pub. No.: US 2008/0181266 A1
(43) Pub. Date: Jul. 31, 2008

(54) Enhanced seeded pulsed fiber laser source

(75) Inventors: Pascal Deladurantaye, St-Joseph de la Pointe-Levy (CA); Robert Larose, Laval (CA); Yves Taillon, Saint-Augustin de Desmaures (CA); Francois Brunet, Quebec (CA)

Correspondence Address: MERCHANT & GOULD PC, P.O. BOX 2903, MINNEAPOLIS, MN, 55402-0903, US

(73) Assignee: INSTITUT NATIONAL D'OPTIQUE, Quebec (CA)

(21) Appl. No.: 11/698,427

(22) Filed: Jan. 26, 2007

(51) Int. Cl. H01S 3/10

(52) U.S. Cl. 372/25

(57) ABSTRACT

A pulsed laser light source for producing amplified light pulses is provided. It includes a three-port optical circulator connected to a first, second, and third waveguide branch, a seed module for generating a pulsed light and propagating the light along the first waveguide branch to the first port of the optical circulator and out the second port to the second waveguide branch, a reflector in the second waveguide branch for reflecting the light back through the second port of the optical circulator for circulation out the third port to the third waveguide branch, and a light output provided in the third waveguide branch for outputting the amplified light pulses. An amplifier is disposed in the second waveguide branch between the optical circulator and the reflector for amplifying the light and an optical modulator operable for modulating the pulsed light is disposed in the third waveguide branch.

### FIELD OF THE INVENTION

The present invention relates generally to the field of laser light sources and more particularly concerns an enhanced seeded pulsed fiber laser source with unfolded cavity design which provides efficient energy extraction and optical pulses with pulse shape flexibility.

### BACKGROUND OF THE INVENTION

Pulsed laser light sources are used in a variety of fields such as material processing, dentistry, range finding, remote sensing, LIDAR (Light Detection and Ranging) or communication-related applications. Different applications require pulsed lasers with different output power; however it is usually desirable to produce a high peak power from a pulsed laser. In general, three techniques are used for this purpose: Q-switching, mode-locking, and gated cascade amplification.

The Q-switching method consists of switching from a high-loss (low quality i.e. low Q) to a low-loss (high quality i.e. high Q) condition in a laser cavity. A Q-switched laser system typically includes a gain medium, pumped by laser diodes or other external pumping source, and a mirror on each side thereof to generate the laser oscillation. The switching between a high-loss and low-loss condition is generally achieved with a high-speed switching device such as an acousto-optic modulator. While in the high-loss condition, the gain medium is pumped and feedback of light into the gain medium is prevented by the modulator. After some time, the gain medium becomes fully inverted and presents its maximum gain. At this point in time, the switching device is used to rapidly revert to a low-loss cavity thereby allowing feedback of light into the gain medium and enabling the build-up of a powerful pulse in the laser through optical amplification by stimulated emission.

The resulting peak power is fairly large, but the spectrum is often composed of several longitudinal modes and the repetition rate is generally low due to the limited repetition frequency of the switching device. Moreover, the pulsewidth is not directly adjustable and varies with the pumping rate, repetition rate and cavity optical length. Another drawback is a “jitter” of the output beam, that is, substantial variations of the delay between the moment when the pulse is triggered and the launching of the laser output pulse.

Mode-locking is another technique by which short pulses of high peak power are produced by synchronizing most of the longitudinal modes of the laser cavity with an internal modulator. Typically, the driving frequency of the modulator corresponds to the round-trip time of the cavity and must be precisely tuned. Therefore, the repetition rate of a mode-locked laser and the pulsewidth are fixed, since they are determined by the physics of the cavity.

In order to have control over the repetition rate and the pulsewidth, a gated cascade amplification scheme may be used. A low-power laser diode pulsed with the desired repetition rate and pulsewidth acts as a seed for a series of amplifiers which increase the pulse power. The amplifiers are usually gated with synchronously activated switches in order to limit the self-saturation of the gain medium in the amplifier chain due to its own noise from amplified spontaneous emission. This configuration has the advantage of separating the pulse generation process from the amplification process, both the spectral and temporal quality of the laser output pulses then depending only on the laser diode source. Directly pulsing the laser diode current can however generate transient effects that can affect both the spectrum and the noise figure of the seed source. Furthermore, longitudinal mode beating can be an important source of high frequency noise which consequently gives rise to peak power fluctuations in the pulse structure. Depending on its amplitude and frequency spectrum, this noise can severely limit the ability to generate stable optical pulses having special shapes with fine structures.

LAROSE et al in U.S. Pat. No. 6,148,011 teaches a self-seeded laser source including a waveguide, an optical pump source, a gain medium for producing seed radiation, as well as a modulator and an array of Bragg gratings for modifying the properties of the seed radiation (see FIG. 1A (PRIOR ART)). Once generated by the gain medium, the seed radiation propagates in the waveguide where it is first pulsed by the modulator. The resulting pulses are then selectively reflected by the Bragg grating, which separates different spectral components of the reflected beam. This reflected beam then travels back to the modulator, which is timed to let only the desired spectral components go through. In this manner, the laser is self-seeded and allows spectrum and wavelength selection from pulse to pulse. Optionally, a second gain medium may be provided between the modulator and Bragg grating to provide further amplification of the signal.

A drawback of the self-seeded source of LAROSE et al. is that the obtained pulse shape includes a step or “pedestal” preceding the desired pulse associated with residual ASE when the second gain medium is used. This is illustrated in FIG. 1 B (PRIOR ART). Another drawback of the self-seeded source of LAROSE et al. is that the modulator extinction ratio must be high in order to prevent spurious lasing of the source due to the parasitic back reflections coming from the output isolator or from other components such as the pump couplers. This ultimately limits the maximum achievable output power of the source and its stability, depending on both the modulator extinction ratio and the back reflection level of the other optical components.

Unseeded or self-seeded pulsed fiber laser designs like the source of LAROSE et al. use intrinsic fluorescence from amplifying fibers of the device to generate optical output pulses, i.e. pulsed laser output. This offers the possibility to use a minimal number of components for generating optical output pulses and to thus keep the devices simple and low-cost.

However, when laser diode (preferably single transverse mode) seed sources are available with the required line-width, it is sometimes advantageous to use a seeded geometry for generating a pulsed laser output. This is the case when the modulation device for generating the pulsed laser output has a low optical power damage threshold. Using a seeded geometry with low optical power damage threshold components and an appropriate seed source ensures that a maximum number of the photons which impinge onto the low damage threshold components lie within a useable optical bandwidth.

There is therefore a need for a low-cost, stable, seeded pulsed fiber laser which allows for easy control over the repetition rate and pulsewidth as well as spectral pulse-shape tuning.

### SUMMARY OF THE INVENTION

It is an object of the present invention to provide a pulsed laser light source that optimises the energy extraction efficiency while providing amplified optical output pulses.

In accordance with one aspect of the present invention, there is therefore provided a pulsed laser light source for outputting amplified light pulses. The pulsed laser light source includes a first, a second and a third waveguide branch, an optical circulator having a first, a second and a third port respectively connected to the first, second and third waveguide branches, and a seed module for generating light pulses and propagating the light pulses in the first waveguide branch towards the first port of the optical circulator for circulation to the second waveguide branch through the second port of the circulator. A reflector is provided in the second waveguide branch for reflecting the light pulses back towards the second port of the optical circulator for circulation to the third waveguide branch through the third port of the circulator. A second-branch amplifier is disposed in the second waveguide branch between the optical circulator and the reflector for amplifying the light pulses circulating therethrough towards and from the reflector. A third-branch optical modulator is disposed in the third waveguide branch, the third-branch optical modulator being operable to be opened and closed in synchronization with the light pulses. A light output is provided in the third waveguide branch downstream the third-branch amplifier for outputting the amplified light pulses.

Preferably, the seed module comprises a seed light source generating a seed light beam of at least quasi-continuous radiation, and a seed light modulator operable to modulate the seed light beam to obtain the light pulses.

Preferably, a third branch amplifier is disposed downstream the third-branch optical modulator for further amplifying the light pulses.

Also preferably, the pulsed laser light source further includes a control system for controlling the operation of the third-branch optical modulator.

In one embodiment of the pulsed laser light source, the control system is operable to open the third-branch modulator before arrival of a leading edge of one of the light pulses coming from the circulator, and close the third-branch modulator after the leading edge and a portion of the light pulse corresponding to a desired pulse duration has gone therethrough.

In another embodiment of the pulsed laser light source, the control system is operable to open the third-branch modulator after arrival of a leading edge of one of the light pulses coming from the circulator, and close the third-branch modulator after passage of a remainder of the corresponding light pulse therethrough.

In yet another embodiment of the pulsed laser light source, the control system is operable to open the third-branch modulator after arrival of a leading edge of one of the light pulses coming from the circulator, and close the third-branch modulator after a portion of the light pulse corresponding to a desired pulse duration has gone therethrough.

In another embodiment, the control system is operable to open the third-branch modulator before arrival of a leading edge of one of the light pulses coming from the circulator, and close the third-branch modulator after passage of the corresponding light pulse therethrough.

The objects, advantages and other features of the present invention will become more apparent and be better understood upon reading of the following non-restrictive description of the preferred embodiments of the invention, given with reference to the accompanying drawing. The accompanying drawing is given purely for illustrative purposes and should not in any way be interpreted as limiting the scope of the invention.

### BRIEF DESCRIPTION OF THE DRAWINGS

FIG. 1A (PRIOR ART) is a schematic illustration of a self-seeded light source according to the prior art of LAROSE et al.; FIG. 1B (PRIOR ART) illustrates the temporal shape of a pulse generated by the source of FIG. 1A.

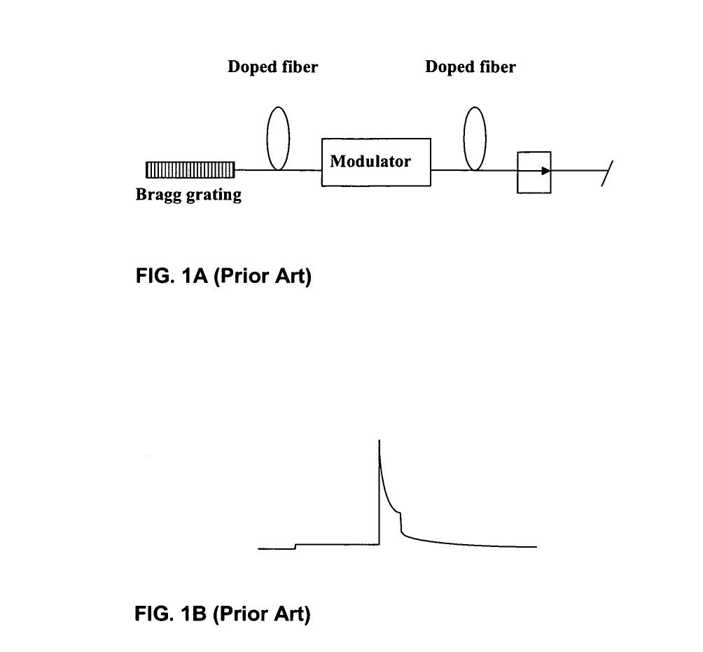

FIG. 2 is a schematic illustration of the pulsed laser light source according to one embodiment of the invention.

FIG. 3 is a schematic illustration of the pulsed laser light source according to another embodiment of the invention.

### DESCRIPTION OF PREFERRED EMBODIMENTS OF THE INVENTION

In the following description, the term “light” is used to refer to all electromagnetic radiation, including but not limited to visible light. Furthermore, the term “optical” is used to qualify all electromagnetic radiation, that is to say light in the visible spectrum and light in other wavelength ranges.

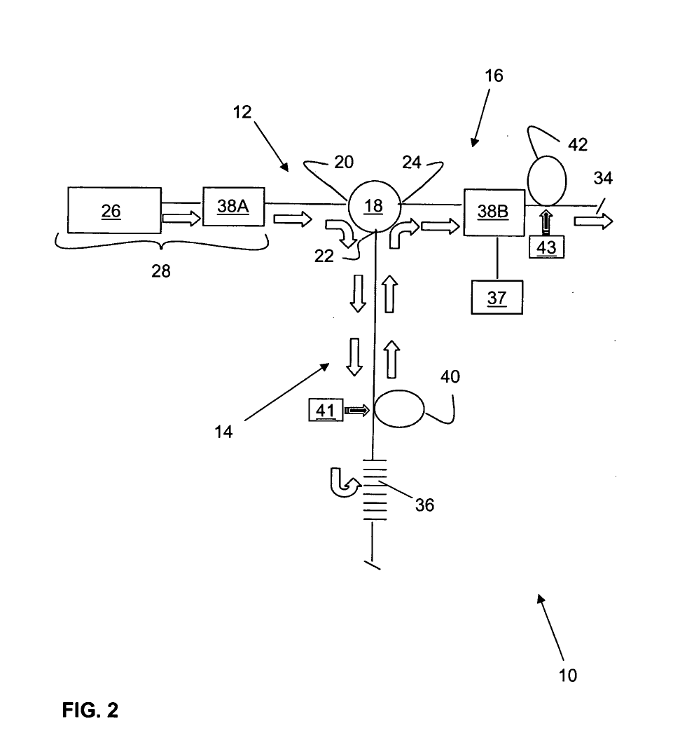

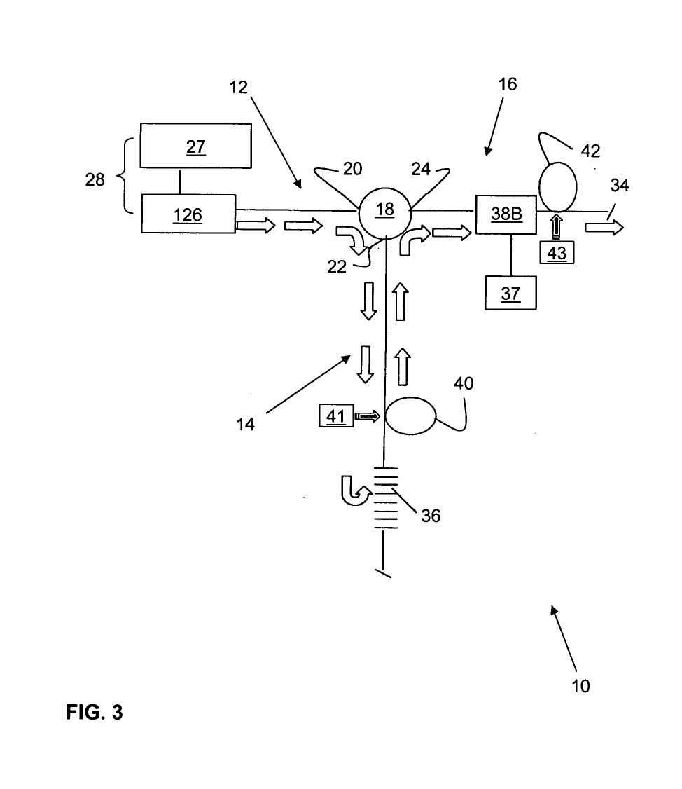

A pulsed laser light source (10) for producing amplified light pulses is shown in FIGS. 2 and 3 according to two preferred embodiments of the invention. As will be apparent from the description below for one skilled in the art, the pulsed laser light source of the present invention provides great versatility in shaping the temporal and spectral profile of the light beam while using readily available and relatively inexpensive components. The temporal profile of the light beam is defined as its intensity as a function of time and defines the width, repetition rate and amplitude shape of the light pulses. The spectral profile of the light beam is defined as its intensity as a function of wavelength.

The pulsed laser light source (10) includes three waveguide branches, namely a first (12), a second (14), and a third (16) waveguide branch. Preferably, each of the waveguide branches (12, 14, and 16) is embodied by a length of optical fiber. The optical fiber may be a standard fiber or a polarisation maintaining (PM) fiber, preferably with a single mode core. It may be single-clad or double-clad (clad-pumped).

In addition, the pulsed laser light source (10) includes a three-port optical circulator (18). The optical circulator (18) has a first (20), a second (22) and a third (24) port connected respectively to the first (12), second (14) and third (16) waveguide branches. It is preferably made out of, or pigtailed with, optical fiber that guides a single transverse mode at the operating wavelength. For example, at wavelengths around 1 μm, integrated circulators pigtailed with PM980 or H11060 fibers are readily available. While the optical circulator (18) induces low losses for light at the operating wavelength traveling from the first port (20) to the second port (22) and from the second port (22) to the third port (24), it induces high losses for light circulating from the second port (22) to the first port (20) and for light circulating from the third port (24) to the second port (22).

First Waveguide Branch

A seed module (28) for seeding the downstream components is provided. The seed module generates a light beam composed of input light pulses having an initial temporal shape. The accompanying drawings show two different embodiments of such a seed module.

In the embodiment of FIG. 2, the seed module (28) includes a seed light source (26) generating a light beam of continuous wave or quasi-continuous wave radiation. The expression “quasi-continuous” is understood herein to designate a light beam having optical pulses with a pulse width which is long when compared to the desired pulse width of the light pulses outputted by the pulsed laser light source (10). The seed light source (26) may be embodied by a laser, an optical source of amplified spontaneously emitted radiation, or any continuous wave (CW) or quasi-continuous wave (quasi-CW) source of radiation be it coherent or incoherent. A preferred seed light source (26) is a single transverse mode laser diode with narrow output linewidth. The light beam generated by the seed light source (26) has a spectral profile which preferably corresponds to a gain spectrum of the gain section of the pulsed laser light source (10) or at least includes within its wavelength range a wavelength overlapping a gain spectrum of this gain section. (The gain section of the pulsed laser light source (10), that is to say the amplifier (40), is described in more detail hereinbelow.) The seed light source (26) may emit linearly polarized light, in which case the three waveguide branches (12, 14, and 16) are preferably embodied by polarization-maintaining fiber. Still in respect of the embodiment of FIG. 2, the seed module also preferably includes a seed light modulator (38A) providing an initial spectral and temporal modulating of the continuous light beam generated by the seed light source (26) into pulses with an initial temporal profile. Preferably, the seed light modulator (38A) is an optical modulator which has high transmission losses when closed but low transmission loses when open. It is preferably fiber pigtailed with single mode fiber to the optical fiber of the first waveguide branch (12). It is preferably embodied by an electro-optic modulator but any other modulation scheme, such as one based on an acousto-optic modulator, an electro-absorption modulator, etc., could also be considered within the scope of the invention.

According to another preferred embodiment shown in FIG. 3, the seed module may include a pulsed seed light source (126) generating the input light pulses directly. The initial temporal profile of the input light pulses is preferably controlled through a pulse format generator (27) incorporated into or associated with the driver of the pulsed seed light source (126).

The seed module (28) is optically connected to the first waveguide branch (12) so that the generated light beam propagates therein towards the first port (20) of the optical circulator (18). As explained above, the optical circulator (18) is such that the light received at the first port (20) is circulated to the second waveguide branch (14) through the second port (22) of the circulator (18).

Second Waveguide Branch

A reflector (36) is provided in the second waveguide branch (14) for reflecting the light beam back towards the second port (22) of the optical circulator (18) for circulation to the third waveguide branch (16) through the third port (24) of the circulator (18). As shown in FIGS. 2 and 3, the reflector (36) is preferably a fiber Bragg grating which has a reflection profile selected so that it reflects only wavelengths corresponding to the desired spectral profile of the output pulses. The fiber Bragg grating may be single- or multi-wavelength and may be chirped, sampled, or of any appropriate design. In the case where the pulsed light beam generated by the seed module (28) already has a spectral profile corresponding to the desired output spectral profile, the reflector (36) could be wideband or of a less discriminatory reflection profile. Alternatively to a Bragg grating, the reflector could for example be embodied by a reflective coating deposited on a facet of the fiber, a bulk mirror butt-coupled to the end of the fiber, a fiber loop mirror, a cascade of fiber Bragg gratings or any other appropriate component or combination of components.

A second-branch amplifier (40) is disposed in the second waveguide branch (14) between the optical circulator (18) and the reflector (36). The input light pulses will therefore encounter the amplifier twice during their trip forward and back in the second branch (14). The second-branch amplifier (40) amplifies the input light pulses a first time after they exit the second port (22) of the optical circulator (18) and a second time after they have been reflected by the reflector (36) and travel back towards the circulator (18). In the preferred embodiments of FIGS. 2 and 3, the second-branch amplifier (40) is a length of optical fiber, either single clad or double-clad, preferably with a single mode core doped with a rare earth element, such as Er, Yb, Nd, etc. In the former case, pump radiation is introduced directly to the gain medium of the fiber core. In the latter case, the pump radiation is introduced first into the inner cladding surrounding the core and is then absorbed by the core—the core acts as the gain medium and the inner cladding acts to carry the pump light that maintains the population inversion in the core. The pumped radiation is produced using an appropriate pump source (41). The pumping energy propagates backwards or forwards or both through the second-branch amplifier (40) to maintain the required population inversion therein. Alternatively, the second-branch amplifier (40) may be a fiber-pigtailed semiconductor optical amplifier (SOA).

Following the second pass of the input light pulses through the second-branch amplifier (40), the amplified input light pulses enter the second port (22) of the optical circulator (18), exit the third port (24) of the circulator (18) and enter the third waveguide branch (16).

Third Waveguide Branch

In the third waveguide branch (16), the input light pulses encounter an optical modulator (38B). The third-branch optical modulator (38B) is preferably fiber-pigtailed with the optical fiber embodying the third waveguide branch (16). It may be an electro-optic modulator but any other modulation scheme, such as one based on an acousto-optic modulator, an electro-absorption modulator, etc., is possible. In the case of the preferred embodiment of FIG. 2, the optical modulator (38B) may or may not be of the same type as that of the seed light modulator (38A).

The third-branch optical modulator (38B) is opened and closed in synchronization with the light pulses to either let through or adjust the temporal shape of the light pulses coming from the third port (24) of the circulator (18), as will be further explained below. It preferably has high transmission losses when closed and low losses when open. In addition, a control system (37) is preferably provided for controlling the operation of the optical modulator (38B). The control system (37) may be embodied by any device or combination of devices appropriate for this purpose, as well known to those skilled in the art.

A light output (34) is provided in the third waveguide branch (16) for emitting the pulsed laser light. An isolator (not shown) may be provided at the light output (34) for preventing parasitic light to enter the device.

Further amplifiers may be provided for increasing the power of the pulsed laser light coming out of the third port (24) of the optical circulator (18). As shown in the preferred embodiments of FIGS. 2 and 3, a second amplifier (42) is preferably disposed in the third waveguide branch (16). As with the first (second-branch) amplifier (40), this second (third-branch) amplifier (42) is preferably single mode and consists preferably of a length of optical fiber doped with a rare earth element, such as Er, Yb, Nd, etc., which is pumped with an appropriate pump source (43).

In operation, in the embodiment of FIG. 2, the seed light source (26) of the seed light module (28) emits a CW optical signal, i.e. a light beam. The light beam travels to the entrance of the seed light optical modulator (38A), which is optically connected to the seed light source (26), for appropriate pulse generation and shaping. In the embodiment of FIG. 3, the seed light source (126) directly produces a pulsed light beam.

The pulsed light beam exits the seed module (28), travels along the first waveguide branch (12) into the first port (20) of the optical circulator (18) and out the second port (22) of the optical circulator (18) with low losses. Most of the light beam impinging onto the second port (22) is prevented from being transmitted back through the first port (20) given that the second port (22) is isolated from the first port (20) through high insertion losses. In this way, the optical circulator (18) prevents detrimental optical feedback into the seed module (28).

Following the transmission through the optical circulator (18), the modulated pulsed light beam coming from the second port (22) goes through the second-branch amplifier (40) a first time as it travels along the second waveguide branch (14). The reflector (36) (embodied by a fiber Bragg grating in FIGS. 2 and 3) placed downstream the amplifier (40) reflects the light beam back along the second waveguide branch (14) and through the amplifier (40) a second time. The peak reflectivity and the optical bandwidth of the reflector (36) are chosen so as to achieve high-reflectivity of the seed light source optical signal, i.e. the light beam generated by the seed light source. The pulsed light beam undergoes a back-and-forth trip, i.e. a double-pass, through this first second-branch amplifier (40), which thereby increases the energy extraction efficiency of the design.

The amplified light beam leaves the second-branch amplifier (40), enters the circulator (18) via the second port (22) and is circulated out the third port (24) to the second modulator (38B) disposed in the third waveguide branch (16).

One function of this third-branch optical modulator (38B) is to prevent Amplified Spontaneous Emission (ASE) from the first gain section, i.e. the second-branch amplifier (40), from reaching subsequent gain sections, i.e. subsequent amplifiers, when the generation of pulses is not in progress. By isolating the amplifying sections, the energy stored in the third-branch amplifier and each of the subsequent amplifiers is increased which promotes high pulse energies of the output light pulses.

Another function of this second optical modulator (38B) is to further refine the shape of the pulses of the light beam in the case where the seed module (28) is used to generate input light pulses with a pulse shape that is only approximately defined: i.e. approximate pulse width, exact pulse repetition rate, and approximate pulse amplitude shape.

In the case where further refining of the pulse shape is needed, the amplified light beam enters the second (third-branch) optical modulator (38B) for further modulation. The generation of the refined output light pulses with the desired temporal and spectral profile as well as amplitude is accomplished through the synchronized use of the seed light modulator and the third-branch optical modulator (38B), i.e. through the opening and closing of the third-branch optical modulator (38B) in synchronization with the light pulses. As explained hereinbelow, the opening and closing of the third-branch optical modulator (38B) is synchronized with, that is to say coordinated with or maintained in step with, the light pulses, and not necessarily with the leading or trailing edge of the pulses. Preferably, the synchronization is carried out using the control system (27).

The control system (27) may be used to adjust each input light pulse by opening the third-branch optical modulator (38B) before arrival of a leading edge of one of the light pulses coming from the circulator (18), and closing the third-branch optical modulator (38B) after the leading edge of the light pulse and a portion of the light pulse corresponding to a desired pulse duration of the desired pulse profile has gone therethrough. Alternatively, in another case, the control system (27) may be used to adjust each input light pulse by opening the third-branch optical modulator (38B) after arrival of a leading edge of the light pulse coming from the circulator (18), and closing the third-branch optical modulator (38B) after passage therethrough of the remainder of the light pulse. In yet another case, the control system (27) may be used to adjust each input light pulse by opening the third-branch optical modulator (38B) after arrival of a leading edge of one of the light pulses coming from the circulator (18), and closing the third-branch optical modulator (38B) after a portion of the light pulse corresponding to a desired pulse duration of the desired pulse profile has gone therethrough.

In addition to using the control system (27) to adjust the temporal profile of the light pulses, as described in the cases above, the control system (27) may also be used to adjust the amplitude of the modulation of the third-branch optical modulator (38B) for further adjustments of the pulse shape.

The control system may also be used to adjust the spectral profile of the light pulses. For example, in the case where the reflector (36) consists of a cascade of fiber Bragg gratings, a delay may be induced between different spectral components of the light pulse corresponding to the difference in the time it takes for the different spectral components of the light pulse to reach the second (third-branch) optical modulator (38B) after being reflected from their respective fiber Bragg gratings. By synchronizing the opening of the second optical modulator (38B) with the time it takes for a particular spectral (wavelength) component of the light pulse to reach the second optical modulator (38B), it is possible to select a particular spectral (wavelength) component and thereby adjust the spectral profile of the light pulse. This concept of wavelength selection is described by LAROSE et al in U.S. Pat. No. 6,148,011. As such, the second (third-branch) optical modulator (38B) may be opened and closed several times in order to obtain the desired spectral profile of the light pulses.

Fine pulse-shape control can thus be accomplished using the second optical modulator, i.e. the third-branch optical modulator (38B), through timing and/or modulation amplitude adjustments.

In the case where no refining of the pulsed light beam is necessary, the second (third-branch) optical modulator (38B) is opened for a time which allows the pulses of predefined shape generated by the initial seed light modulator to be transmitted with low losses through the optical modulator (38B). The optical modulator (38B) is then closed after the passage of the pulse.

It should be noted that in the preferred embodiment of FIG. 3, the generation of the seed light beam is accomplished by the seed light source (126) and the pulse format generator (27) associated with the driver of the seed light source (126). For high efficiency, the seed light source (126) cannot be operated in continuous wave (CW) mode. As such, the fine adjustments regarding the pulse shape of the pulsed light beam are preferably carried out by the seed light source modulator, that is to say, by the pulse format generator (27). Of course, minor refinement of the pulsed light beam may be carried out by the second (third-branch) optical modulator (38B) as described above.

After exiting the optical modulator (38B), the generated optical pulse is preferably further amplified by additional fiber amplifiers, for example by the third-branch amplifier (42) located in the third waveguide branch (16) according to the preferred embodiment of FIGS. 2 and 3.

Finally, the pulsed light beam with the desired pulse shaping exits the pulsed laser light source (10) through a light output (34) provided in the third waveguide branch (16).

Advantageously, the proposed geometry of the pulsed laser light source (10) shown in FIG. 2 allows using a continuous wave (CW) or quasi-continuous wave (quasi-CW) seed light source (26) to generate arbitrary temporal pulse shapes out of the CW or quasi-CW seed light beam through the use of two optical amplitude modulators (38A and 38B). Moreover, the position of the optical amplitude modulators (38A and 38B) in conjunction with the use of the three-port optical circulator (18) allows the first modulator (38A) to be used to produce the required pulse shape and to isolate the first gain section (i.e. the first amplifier section) from the seed light beam when pulses are not required and the second optical modulator (38B) to be used to further shape the light pulses and to promote higher energy extraction efficiency in the subsequent amplifiers (e.g. third-branch amplifier (42)) by isolating them from the ASE generated in the second-branch amplifier (40).

Given the non-negligible optical losses in the light beam as it travels from the second port (22) to the third port (24) of the circulator (18), the geometry of the pulsed laser light source (10) as illustrated in FIGS. 2 and 3 allows for the amplification of the optical pulses generated using a double-pass configuration into at least one gain (amplifier) section thereby advantageously increasing the energy extraction efficiency of the design. Moreover, the disposition of the optical modulator (38B) in the third waveguide branch (16) in this geometry offers the possibility to optimize the energy in the pulsed light beam before the second gain section (i.e. the section in the third waveguide branch (16) in which the second amplifier (42) is disposed). For a fixed optical damage threshold of the optical modulator (38B), the geometry of FIGS. 2 and 3 allows amplifying the light beam exiting the second port (22) to a level practically equal to the damage threshold of the optical modulator (38B) disposed in the third waveguide branch (24) plus the amount of the losses incurred by the light beam as it passes from the second port (22) to the third port (24) of the circulator (18) on its way to the optical modulator (38B). More importantly, the position of the second modulator (i.e., that of optical modulator (38B) disposed in the third-waveguide branch (24)) is such that the second modulator is the very last component before the second gain section, thus allowing for the injection of a maximum pulse energy—a pulse energy that is practically equal to the modulator damage threshold minus the modulator insertion losses—into the second gain medium (i.e., the third-branch amplifier (42)) and thereby providing enhanced energy extraction efficiency in the third-branch amplifier (42).

Numerous modifications could be made to any of the embodiments described above without departing from the scope of the present invention as defined in the appended claims.

1. A pulsed laser light source for outputting amplified light pulses, comprising:
a first, a second and a third waveguide branch;
an optical circulator having a first, a second and a third port respectively connected to the first, second and third waveguide branches;
a seed module for generating light pulses and propagating said light pulses in the first waveguide branch towards the first port of the optical circulator for circulation to the second waveguide branch through the second port of said circulator;
a reflector provided in the second waveguide branch for reflecting said light pulses back towards the second port of the optical circulator for circulation to the third waveguide branch through the third port of said circulator;
a second-branch amplifier disposed in the second waveguide branch between the optical circulator and the reflector for amplifying said light pulses circulating therethrough towards and from the reflector;
a third-branch optical modulator disposed in the third waveguide branch, the third-branch optical modulator being operable to be opened and closed in synchronization with the light pulses; and
a light output provided in the third waveguide branch downstream the third-branch optical modulator for outputting said amplified light pulses.

2. The pulsed light source according to claim 1, wherein each of the first, second and third waveguide branches comprises a length of optical fiber.

3. The pulsed light source according to claim 1, wherein the optical circulator induces high losses for light circulating from the second port to the first port and for light circulating from the third port to the second port.

4. The pulsed laser light source according to claim 2, wherein the optical circulator comprises fiber that guides a single transverse mode at an operating wavelength of said pulsed laser light source.

5. The pulsed laser light source according to claim 1, wherein the seed module comprises a seed light source generating a seed light beam of at least quasi-continuous radiation, and a seed light modulator operable to modulate the seed light beam to obtain said light pulses.

6. The pulsed laser light source according to claim 5, wherein said seed light beam of at least quasi-continuous radiation comprises continuous wave radiation.

7. The pulsed laser light source according to claim 5, wherein the seed light source is selected from the group consisting of a laser and an amplified spontaneous emission source.

8. The pulsed laser light source according to claim 5, wherein the seed light modulator is a first-branch optical modulator external to the seed light source provided in the first waveguide branch downstream the seed light source.

9. The pulsed laser light source according to claim 1, wherein the seed module comprises a pulsed seed light source comprising a pulse format generator integral thereto.

10. The pulsed laser light source according to claim 1, wherein the reflector is a Bragg grating.

11. The pulsed laser light source according to claim 1, wherein said second-branch amplifier is a length of rare-earth doped optical fiber.

12. The pulsed laser light source according to claim 1, further comprising a pump source associated with said second-branch amplifier for pumping said second-branch amplifier.

13. The pulsed laser light source according to claim 1, further comprising a control system for controlling the operation of the third-branch optical modulator.

14. The pulsed laser light source according to claim 13, wherein said control system is operable to open and close said the third-branch optical modulator in synchronization with each of said light pulses.

15. The pulsed laser light source according to claim 14, wherein said control system is operable to open said third-branch modulator before arrival of a leading edge of one of said light pulses coming from the circulator, and close said third-branch modulator after said leading edge and a portion of said one of said light pulses corresponding to a desired pulse duration has gone therethrough.

16. The pulsed laser light source according to claim 14, wherein said control system is operable to open said third-branch modulator after arrival of a leading edge of one of said light pulses coming from the circulator, and close said third-branch modulator after passage of a remainder of said one of said light pulses therethrough.

17. The pulsed laser light source according to claim 14, wherein said control system is operable to open said third-branch modulator after arrival of a leading edge of one of said light pulses coming from the circulator, and close said third-branch modulator after a portion of said one of said light pulses corresponding to a desired pulse duration has gone therethrough.

18. The pulsed laser light source according to claim 14, wherein said control system is operable to open said third-branch modulator before arrival of a leading edge of one of said light pulses coming from the circulator, and close said third-branch modulator after passage of the one of said light pulses therethrough.

19. The pulsed laser light source according to claim 1, further comprising an additional third-branch amplifier provided in the third waveguide branch between the circulator and the light output for further amplifying said light pulses.

20. The pulsed laser light source according to claim 19, further comprising a pump source associated with each of said second-branch and third-branch amplifiers for pumping said second-branch and third-branch amplifiers.
